(19) United States
(12) Patent Application Publication
(10) Pub. No.: US 2004/0070617 A1
(43) Pub. Date: Apr. 15, 2004

(54) Method, system and article of manufacture for creating composite objects and executable user interfaces for these objects that utilize relationships represented by metadata

(76) Inventors: Roger Sippl, Woodside, CA (US); Chris Maloney, Overland Park, KS (US); Deborah Scharfetter, Los Altos, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/603,979

(22) Filed: Jun. 24, 2003

Related U.S. Application Data
(60) Provisional application No. 60/391,386, filed on Jun. 24, 2002.

(51) Int. Cl. G09G 5/00

(52) U.S. Cl. 345/764

(57) ABSTRACT

The present invention relates to a method of dynamically relating a first operation to a second operation in forming a desired relationship. The method comprises searching in an application dictionary for operations involving one or more characteristics relating to the first operation and the second operation based on a user input. The method selects the first operation and the second operation from the application dictionary. Finally the method joins the first operation to the second operation to form the desired relationship. The present invention is also an article of manufacturing comprising a computer usable medium having computer readable program code embodied therein configured to perform the foregoing method. Finally, the present invention also comprises a computer system having a computer which executes the foregoing described method.

The present invention claims the benefit of U.S. Provisional Application No. 60/391,386 filed on Jun. 24, 2002 entitled: “A Semantic Search Technique For Finding Web Services And Other Data Processing Procedures, An Algebra For Relating Multiple Such Procedures Together, And A Presentation Methodology For Rendering One Or More Of Them Into An Ad Hoc Human Interface For Transactions And Information Retrieval,” whose disclosure is incorporated herein by reference.

### TECHNICAL FIELD OF THE INVENTION

The present invention relates to a method, system and article of manufacture for a computer program to create composite objects from one or more databases.

### BACKGROUND OF THE INVENTION

U.S. Pat. No. 6,441,834 discloses a hyper-relational system in which the user may “drag and relate” different elements from different systems, using different computational components. However, although the patent addresses elements from different systems, it requires a pre-defined “class-relation matrix” to define the relationship between these elements. This reduces the flexibility of the system.

U.S. Pat. No. 5,848,424 also discloses a class relation matrix, which must be predefined by the user to define the relationship between various objects or elements. This again reduces the flexibility of the system.

Finally, U.S. Pat. No. 5,555,403 discloses generally database tables.

Thus, there is a need to create a system in which the relationship of various operations involving data elements from various sources are not pre-defined, thereby providing for greater flexibility.

### SUMMARY OF THE INVENTION

The present invention is a method of dynamically relating a first operation to a second operation in forming a desired relationship. The method comprises searching in an application dictionary for operations involving one or more characteristics relating to the first operation and the second operation based on a user input. The method selects the first operation and the second operation from the application dictionary. Finally the method joins the first operation to the second operation to form the desired relationship. The present invention is also an article of manufacturing comprising a computer usable medium having computer readable program code embodied therein configured to perform the foregoing method. Finally, the present invention also comprises a computer system having a computer which executes the foregoing described method.

The present invention also relates to a method of establishing a desired relationship between a first object type and a second object type. The method comprises selecting the first object type and the second object type. Further, the method selects the desired operation to be used to relate the first object type to the second object type. The method further establishes a desired transformation of data from the first object type to be input to the desired operation. Finally, the method establishes a desired transformation of the output of the desired operation to be data of the second object type. The present invention is also an article of manufacturing comprising a computer usable medium having computer readable program code embodied therein configured to perform the foregoing method. Finally, the present invention also comprises a computer system having a computer which executes the foregoing described method.

### BRIEF DESCRIPTION OF THE DRAWINGS

FIG. 1 is a schematic diagram showing a three-tiered architecture between a human interface, the shared business logic and the shared data tables.

FIG. 2 is a screen shot showing an orders table.

FIG. 3a is a screen shot of an Application Browser Application Dictionary Explorer window.

FIG. 3b is a screen shot showing search results.

FIG. 4 is a screen shot showing a FindCustomer form, automatically rendered.

FIG. 5a is a screen shot showing FindCustomers and Find Orders operation, with Join Mode tool tip visible.

FIG. 5b is a screen shot showing FindCustomer and Find Orders operations joined.

FIG. 5c is a screen shot showing a Join Toolbox.

FIG. 6 is a screen shot showing a Form; Modeler.

FIG. 7a is a screen shot showing a Blank form, now joined.

FIG. 7b is a screen shot showing Typing in a value and putting the cursor over the Execute button.

FIG. 7c is a screen shot showing post-Execute results.

FIG. 8a is a screen shot showing a Return to Design mode and add the UpdateOrders operation to the form.

FIG. 8b is a screen shot showing a Merge mode, with tool tip visible.

FIG. 8c is a screen shot showing a Merge the Orders tables by dragging and dropping.

FIG. 8d is a screen shot showing the populated Order table, with merged operations.

FIG. 9a is a screen shot showing an Enterprise Object Type Editor, Elements tab.

FIG. 9b is a screen shot showing an Enterprise Object Type Editor, Operations tab.

FIG. 9c is a screen shot showing an Enterprise Object Type Editor, Relationships tab.

FIG. 10a is a screen shot showing a Form Wizard, Step 1: Choose the Object Types to include on the form.

FIG. 10b is a screen shot showing a Form Wizard, Step 2: Choose the operations for the form.

FIG. 10c is a screen shot showing a Form Wizard, Step 3: Select layout options and finish the form.

FIG. 10d is a screen shot showing a Completed form results from the Form Wizard from FIGS. 10(a-c).

FIG. 11a is a screen shot showing Adding a Relationship to an EOT.

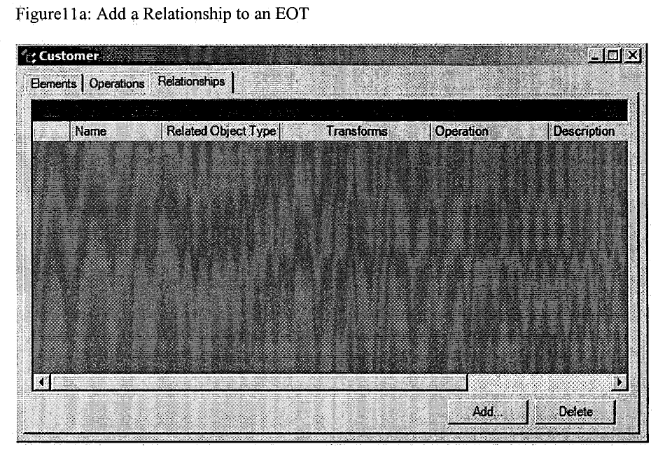

FIG. 11b is a screen shot showing Choosing the EOT to relate.

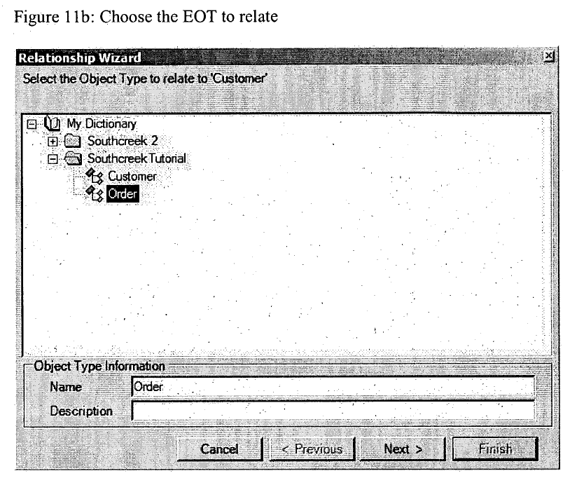

FIG. 11c is a screen shot showing the selection of the operation used to create the relationship.

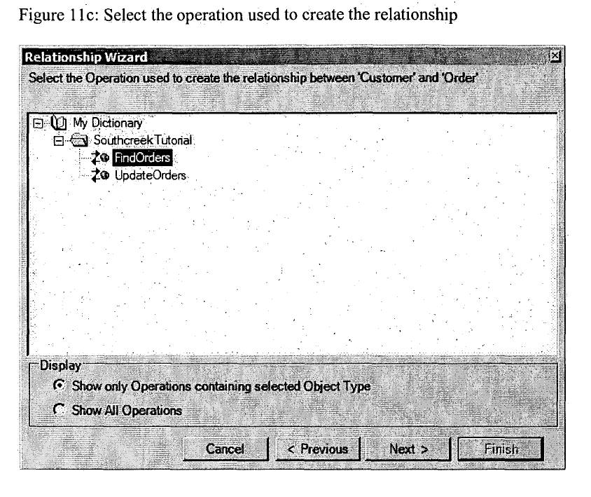

FIG. 11d is a screen shot showing the Editing of the Transforms.

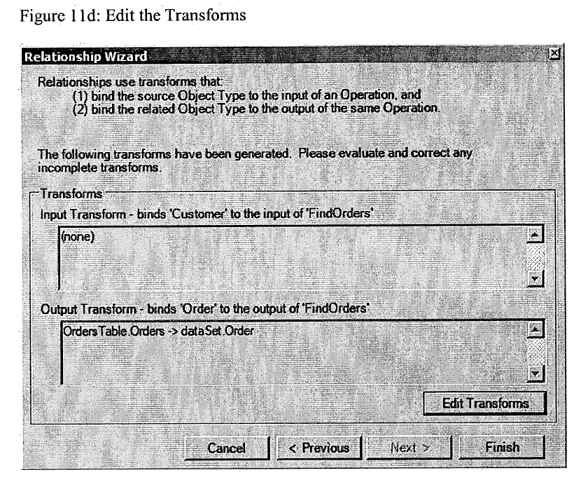

FIG. 11e is a screen shot showing Transforms window.

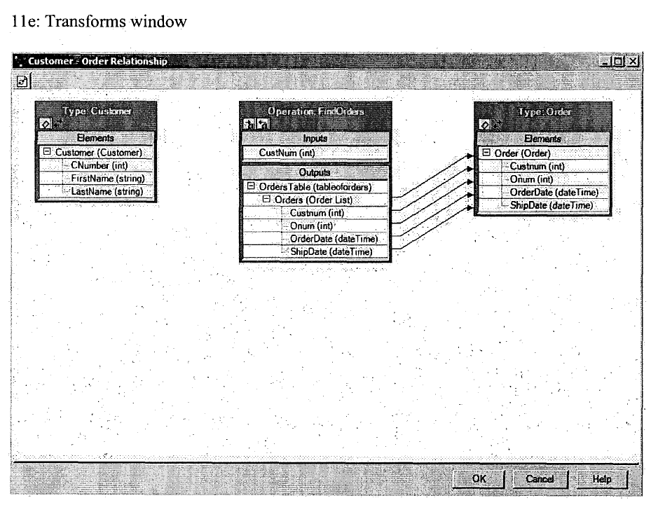

FIG. 11f is a screen shot showing Transforms completed.

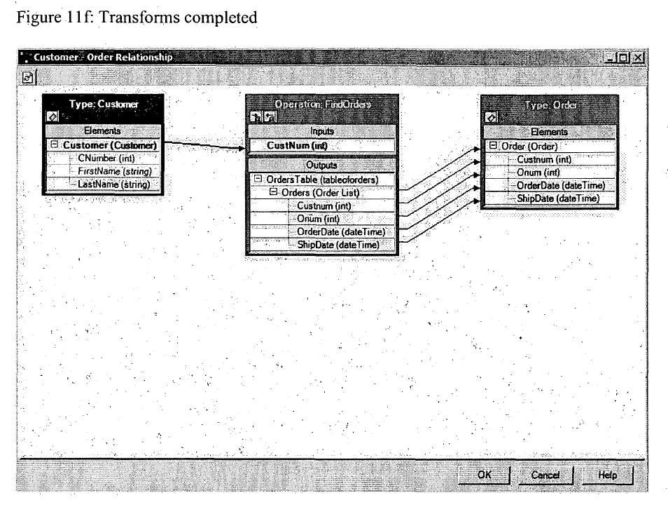

FIG. 12a is a screen shot showing creating a form with a Relationship Join Using the Form Wizard.

FIG. 12b is a screen shot showing Choosing the operations for the form.

FIG. 12c is a screen shot showing the Select layout options and finish the form.

FIG. 12d is a screen shot showing the Form Created with a Relationship Join using the Form Wizard.

FIG. 13a is a screen shot showing an Enterprise Modeler showing Customer and Order icons, without Customer expanded.

FIG. 13b is a screen shot showing an Enterprise Modeler showing Customer and Order icons, with Customer expanded to show Relationships.

FIG. 13c is a screen shot showing an Enterprise Modeler showing more complex relationships, including line labels.

FIG. 13d is a screen shot showing an Enterprise Modeler showing Customer, Call, and Order EOTs, with Customer expanded to show Relationships.

FIG. 13e is a screen shot showing a Relationships panel.

FIG. 14 is a schematic diagram of a computer network in which the present invention is used.

### GLOSSARY

The following is a glossary of some of the terms used in this application.

Operation: A Web service operation, database management system stored procedure, or any other programmatic interface that might take inputs and might returns outputs, possibly after performing processing.

Object Type: An object type is a collection of zero or more elements, arrays of elements, arrays of arrays, and groups of such elements and arrays, collected together with zero or more of the operations that create them or otherwise manipulate them. These operations typically take some or all of the elements as inputs, or return some or all of the elements as outputs. Object types may have relationships to other object types.

Relationship: For the purpose of this invention, a relationship has five parts to its, definition. When instantiated, there is an additional sixth, part. The first five parts are:

Primary Object Type

Input Transform

Operation

Output Transform

Related Object Type

When rendered into an executable user interface, a sixth part is created, which is the trigger. For example, if the Customer object type were related to the Order object type by the two fields first name and last name, then an operation or action that changed either of the values for those fields in the form's dataset would trigger the execution of the relationship. The execution would include running the input transform to take those two values out of the dataset and entering them as inputs into the operation, for example, FindOrders. The operation would be executed, and the outputs of the operation would be transformed and put into the dataset elements for the related object type, for example, Orders.

Transform: A Transform may simply be the copying of one or more elements to or from some storage, or it might include some manipulation of those elements. For example, to turn an old product number into an new product number, the old number may need to have a dash and two zeros appended to it. Or, the two fields first name and last name may be combined into one name field. It is also possible that some operation may need to be invoked to provide a more complex or unknown transformation. Finally, a Transform can be any combination of these things, in a chain of any length.

Domain: The universe of values that are comparable to one another, or can be operated upon together in a meaningful way, using a common set of operators. For example, the set of integers is a domain because, when assigned to variables, those variables can be compared to each other for equality, and this comparison has meaning. One could say that there exists a X domain of customer numbers because they can be assigned to variables, A and B, and the two variables either hold the same customer number or they do not. Two variables, X and Y, containing shipping dates (elements drawn from the domain of “ship ping dates”) can be compared and either the X shipment occurred before the Y shipment, or the Y shipment occurred before the X shipment, or they both occurred on the same date. However, one could not ask if customer number A is equal to the shipment date X. Further, one could not apply operators used on the shipping dates domain to elements of the customer number domain: it makes no sense to ask if customer number A shipped before or after customer number B. If two object types each contain elements drawn from the same domain, then it is clear that a relationship can be built between objects instantiated from those object types. Also, there can be indirect relationships via transformations, or transformations can rep lace the knowledge that there are common domains that are named.

Application Dictionary: A repository of metadata information about the semantics of operations, their inputs, their outputs, the object types that they create or manipulate, the relationships between those object types, and the domains that are used in those relationships. An Application Dictionary can reside on a client computer and/or on a server. When on a client computer it becomes a personal Application Dictionary; when on a server, it holds the body of semantic information collected by a community of users.

### Description

The present invention is a technique for rendering a human interface form for a computer screen that allows the user to interact with one or more software operations that provide interfaces for data input, output, both, or neither, and which may perform processing, which might typically be custom retrieval and/or transactional logic, but could be any logic defined internally to those operations.

Metadata from a repository is used to determine how the form should appear and behave, based on semantic information that has been collected from a user or user community. The metadata could include information about the purpose of the operation, as well as the relationships among the operations, and the entities the operations manipulate.

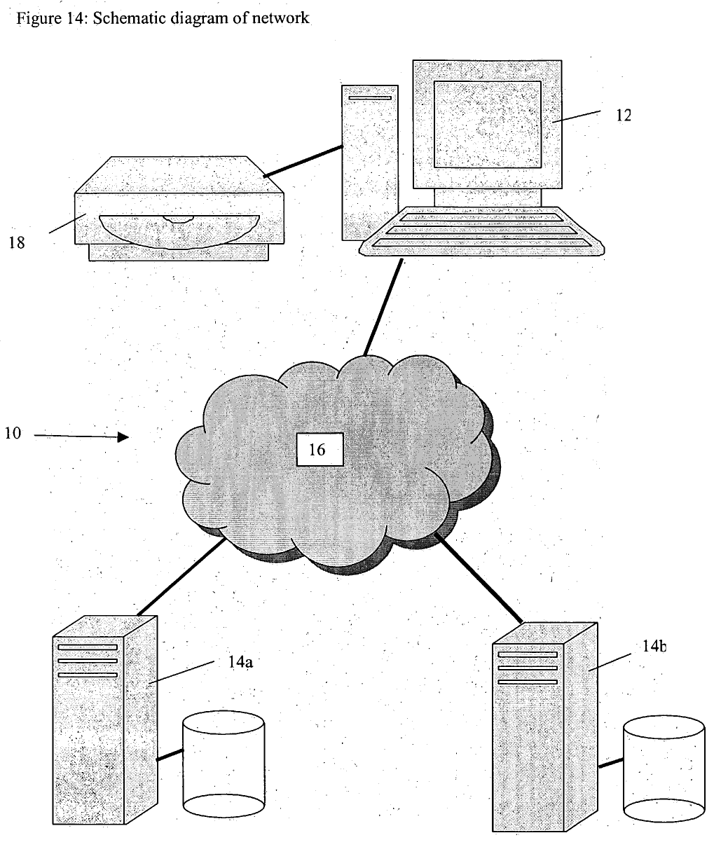

Referring to FIG. 14, there is shown a schematic diagram of a network 10. In the networked system 10, a computer 12 can act as a “client” computer 12 by rendering a human interface that is a transactional form. Operation executions requested by a form running on a client may actually be executed by code running on the client computer 12 and/or one or more servers 14a & 14b. This form may contain fields, tables, labels, buttons and other user interface controls. As is well known to those skilled in the art, the computer 1.2 can communicate with the servers 14 through any type of network 16, such as an intranet or the internet. The client computer 12 may have a storage device 18, such as a hard disc drive or a CD-ROM, attached thereto. The device 18 can read computer usable medium (such as a CD) having computer readable program code embodied therein configured to perform the method described hereinafter. Although the computer usable medium having the computer readable program code of the present invention can be readfrom a device 18 attached to the client computer 12, the computer usable medium can also be attached to a server computer 14 and the program is loaded on the client computer 12 through the network 16.

This form may be said to “contain operations” in the sense that these controls might be connected, via software invention, to the inputs and outputs of operations that may exist on the local client computer 12, one or more servers 14, or both. The form probably contains mere references to those operations and the knowledge of how to invoke those operations.

This form may also contain buttons that could be clicked to signal the desired execution of the actual operations that might exist outside of the form, and communicate with those operations by possibly sending inputs, and receiving outputs. Any operation could, however, be a script that is actually contained within the form.

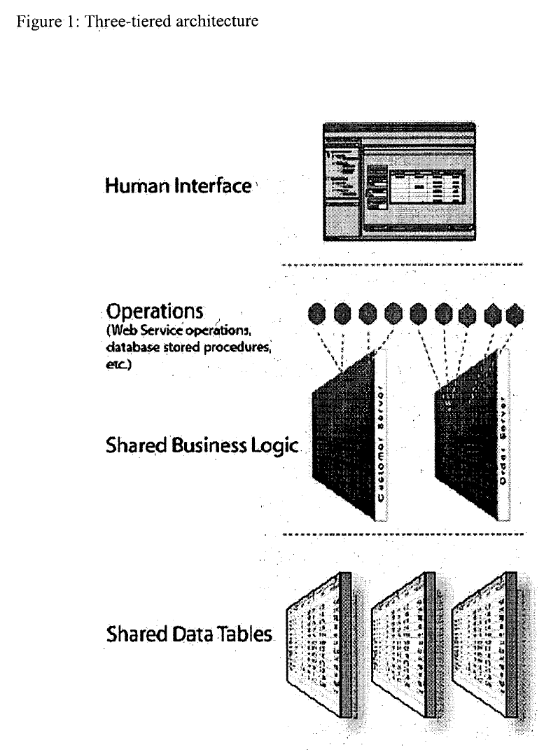

See FIG. 1—Three-Tiered Architecture

Consider the following operations and their input and output parameters.

IN OUT OUT OUT

FindCustomer(EMailAddress, FirstName, LastName, CNumber)

IN OUT

FindOrders(CustNum, OrdersTable)

IN

UpdateOrders(OrdersTable)

The parameters have the following type descriptions.

| | |
|---|---|
| EMailAddress | type character string |
| FirstName | type character string |
| LastName | type character string |
| CNumber | type integer |
| CustNum | type integer |
| OrdersTable | type tableoforders |

A table of orders, the OrdersTable, has columns with the following types.

| | |
|---|---|
| Custnum | type integer |
| OrderId | type integer |
| Orderdate | type integer |
| ShipmentDate | type character string |

The first operation, FindCustomer, takes EMailAddress as an input parameter and finds basic customer information. It may just do a simple database query to a local database, or it may check permissions, search several databases that have been collected from several different mergers, and even ask another application server to check other places as well. The user does not know, nor does it matter; the service of this operation is simply provided for the user, and hides any of this complexity. The outputs of the FindCustomer operation are FirstName (First Name of the Customer), LastName (Last Name of the Customer), and Cnumber (Customer Number).

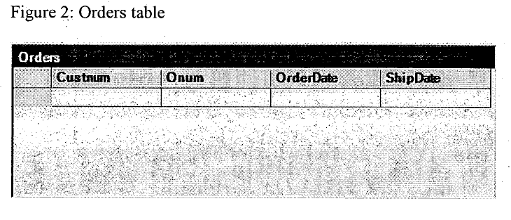

The second operation, FindOrders, takes a CustNum (customer number) as input and returns information about what the customer has ordered (OrdersTable). This output parameter, OrdersTable, is a table data structure, as shown in FIG. 2.

A customer services representative may need a form to use while on the phone so he or she can locate a customer's orders. For example, customers may call frequently to ask what items they have on order. A company may have a Customer Relationship Management product to perform this search using a form, but that form requires a customer number. Perhaps the customer does not know that number; however, the customer always knows his or her email address, and the best way to look up a customer's information of any kind in the data processing systems is to use the email address.

Therefore, the goal is to produce a human interface that an information worker in the support department can use to enter a customer's email address and get a list of the items the customer ordered. The data processing system interfaces can do this “internally,” and provide programmatic application programming interfaces (APIs), but the user does not know of any human interface available in any of the company's systems that does exactly this look up.

Furthermore, the customer information may be on a different server than the order information. Perhaps the customer information system was purchased as an off-the-shelf product, but the order management system was written by the company's own internal MIS department. Therefore, there is a need to create a “composite application” by rendering a form that can communicate with both of these disparate systems.

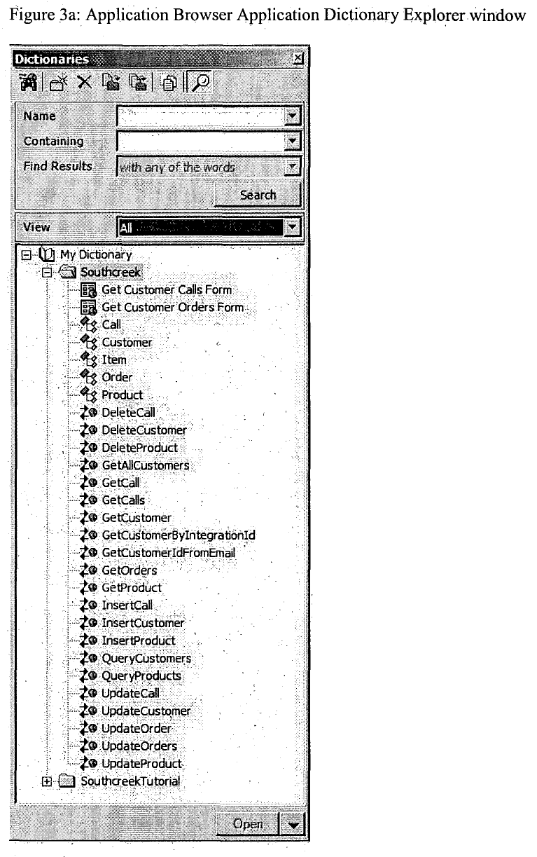

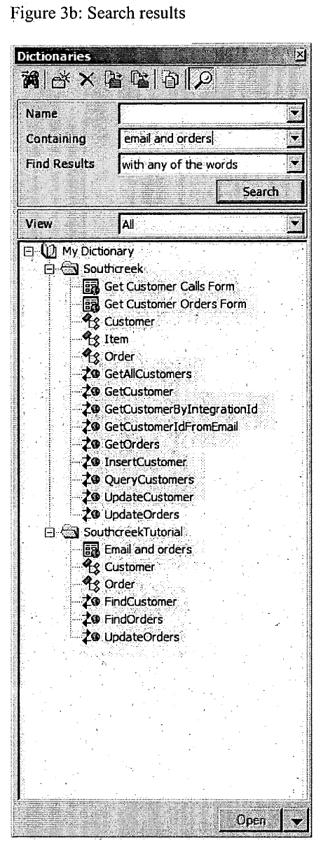

The first step is to find the two operations that can perform the tasks needed, FindCustomers and FindOrders. To do this, the user runs an Application Browser and uses the Application Dictionary Explorer window to search for these operations. The Application Dictionary can be stored on a local storage device to the client computer 12, or it can also be stored on the network 12 and attached to a server computer 14. In the event the Application Dictionary is stored on a server computer 14, it may be shared with multi-users. In the event the Application Dictionary is stored on a local storage device to the client computer 12, then the Application Dictionary would be private to the user of the client computer 12. The metadata and the relationship of the metadata contained in the Application Dictionary may be inputted by the user or it may be downloaded from a server computer 14. In the event the Application Dictionary I stored on a local storage device to the client computer 12, and the metadata and the relationship is down loaded from a server computer 14, the user can customize the Application Dictionary. The Application Dictionary Explorer window of the Application Browser is shown in FIG. 3a.

Since the user wants interfaces that can take an email address and return order information, he types “email and orders” into the search window and clicks the Search button. This search locates the FindCustomer operation, since it takes a parameter called EMailName. The search would also locate the FindOrders operation, because of the Orders parameter, but also because FindOrders contains the word “orders.” This search is shown in FIG. 3b.

The Application Dictionary will find matches, partial matches, and indirect matches. Indirection is used to find forms or operations that are not text string matches, but are related to things that match. For example, a form named “jimsforml” may be found by searching for “emailnanie” because that form might use the FindOrders operation. The searching algorithm finds the form, but lists it lower in the result set than it would list a form containing “emailname” in its name. The algorithm the Application Dictionary uses is specifically tuned to give a prioritized: list as a result set of forms, operations, object types, or other dictionary components, so that the things that the user is looking for are more likely to be near the top of the list.

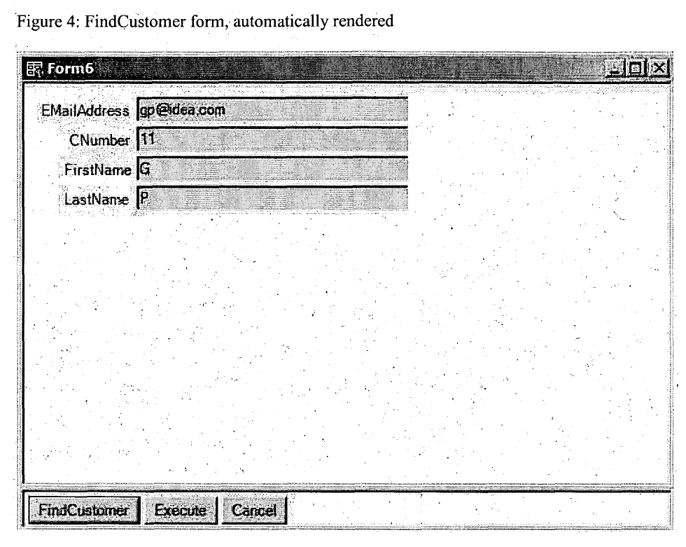

The user can now create a new, blank form using a variety of means, such as selecting New Form from the File menu. The user can then drag and drop the FindCustomer operation into the form, and a form is automatically generated, as shown in FIG. 4. The messages generated by the present invention to execute the example shown in FIG. 4 are as follows:

Request:
<?xml version=“1.0” encoding=“utf-8”?>
<soap:Envelope xmlns:soap=“http://schemas.xmlsoap.org/soap/envelope/”
xmlns:soapenc=“http://schemas.xmlsoap.org/soap/encoding/” xmlns:tns=“http://aboveallsoftware.com/SouthcreekTutorial/”
xmlns:types=“http://aboveallsoftware.com/SouthcreekTutorial/encodedTypes”
xmlns:xsi=“http://www.w3.org/2001/XMLSchema-instance”xmlns:xsd=“http://www.w3.org/2001/XMLSchema”>

<soap:Body soap:encodingStyle=“http://schemas.xmlsoap.org/soap/encoding/”>

<tns:FindCustomer>

<EMailAddress xsi:type=“xsd:string”>gp@idea.com</EMailAddress>

</tns: FindCustomer>

</soap:Body>

</soap:Envelope>
Response:
<?xml version=“1.0”encoding=“utf-8”?>
<soap:Envelope xmlns:soap=“http://schemas.xmlsoap.org/soap/envelope/”
xmlns:soapenc=“http://schemas.xmlsoap.org/soap/encoding/“xmlns:tns=“http://aboveallsoftware.com/SouthcreekTutorial/”
xmlns:types=“http://aboveallsoftware.com/SouthcreekTutorial/encodedTypes”
xmlns:xsi=“http://www.w3.org/2001/XMLSchema-instance” xmlns:xsd=“http://www.w3.org/2001/XMLSchema”>

<soap:Body soap:encodingStyle=“http://schemas.xmlsoap.org/soap/encoding/”>

<tns:FindCustomerResponse>

<Customer href=“#id1” />

</tns:FindCustomerResponse>
<tns:Customer id=“id1” xsi:type=“tns:Customer”>

<CNumber xsi:type=“xsd:int”>11</CNumber>
<FirstName xsi:type=“xsd:string”>G</FirstName>
<LastName xsi:type=“xsd:string”>P</LastName>

</tns:Customer>

</soap:Body>

</soap:Envelope>

The user can immediately use this form. When he clicks the FindCustomer button, the cursor moves to the EmailAddress field because it is the first input parameter of thee FindCustomer operation. If the user types gp@idea.com and clicks the Execute button, the other three fields fill with data that comes back from the call to the FindCustomer operation, for example, first name “G”, last name “P” and customer number “11.”

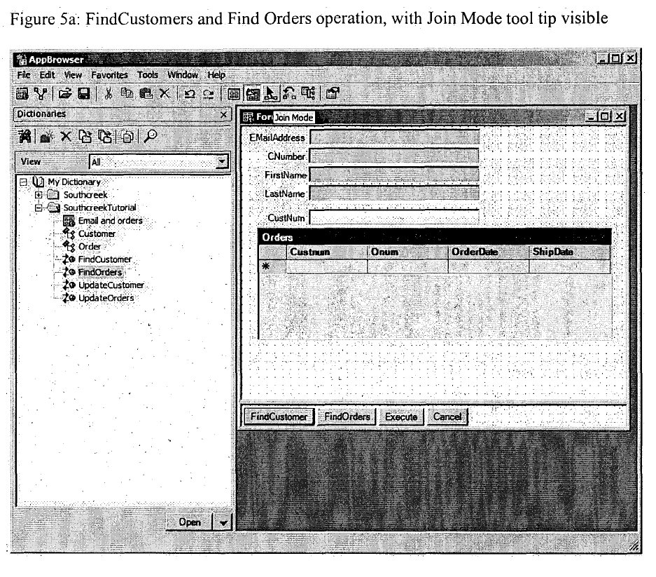

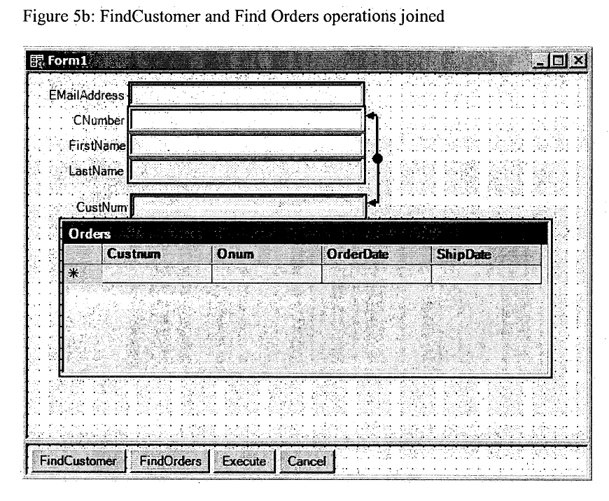

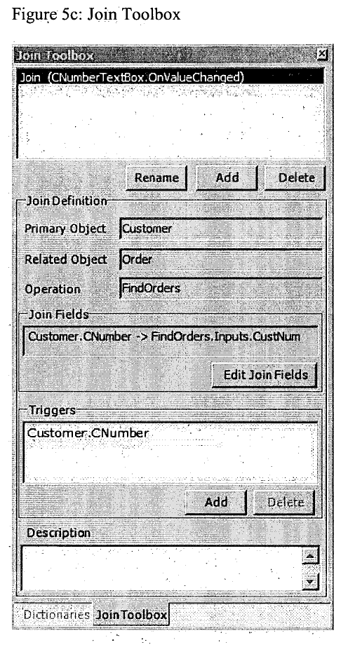

The initial objective, however, was to view the customer's order, based on his email address. The user can now also drag the FindOrders operation into the form and drop it, and more field controls and another button, the FindOrders button, will be rendered, as shown in the FIGS. 5a-c. In the Join Mode as shown in FIG. 5a, the user simply clicks on the field identified as “CNumber” and drags it into the field identified as “Custnum.”

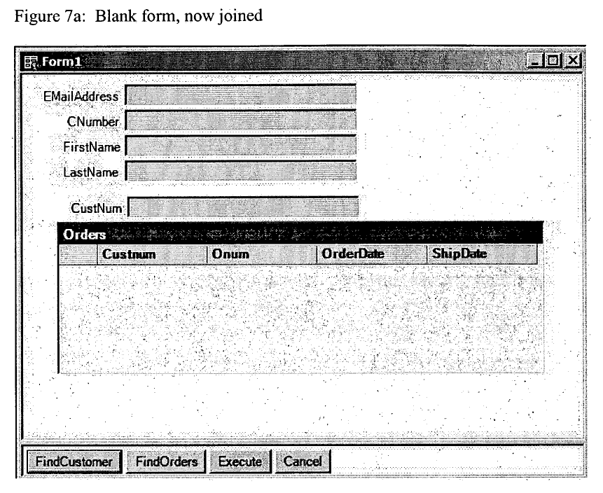

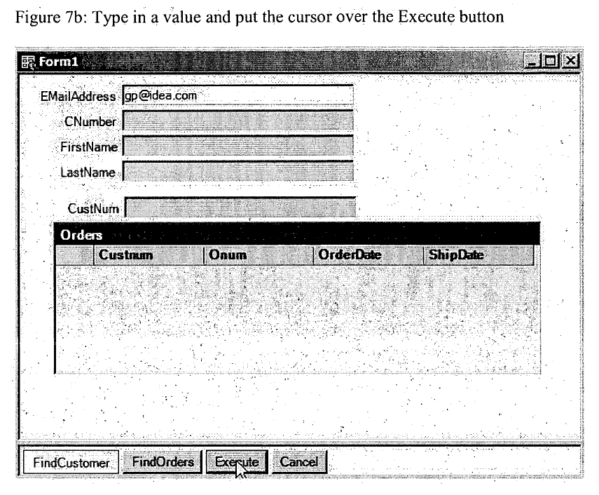

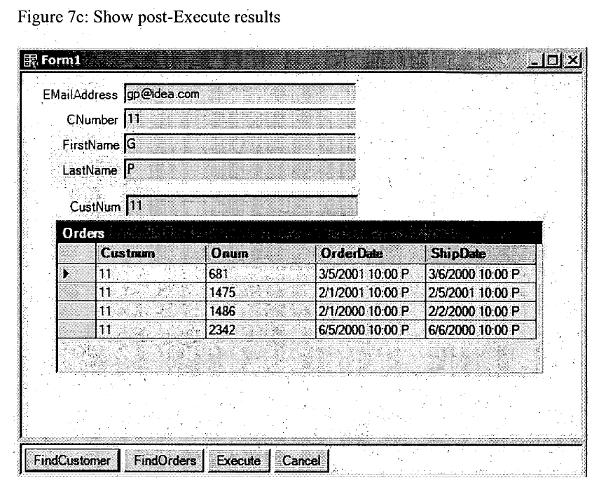

When the user-clicks FindOrders button, the cursor moves to the Custnum field on the screen for the first input parameter of the FindOrders operation. If the user types “111” in the Custnum field and clicks the Execute button, all of the orders for GP display, shown in FIGS. 7a-c. The messages generated by the present invention to execute the example shown in FIG. 7c are as follows:

Request:
<?xml version=“1.0” encoding=“utf-8”?>
<soap:Envelope xmlns:soap=“http://schemas.xmlsoap.org/soap/envelope/”
xmlns:soapenc=“http://schemas.xmlsoap.org/soap/encoding/”xmlns:tns=“http://aboveallsoftware.com/SouthcreekTutorial/”
xmlns:types=“http://aboveallsoftware.com/SouthcreekTutorial/encodedTypes”
xmlns:xsi=“http://www.w3.org/2001/XMLSchema-instance”xmlns:xsd=“http://www.w3.org/2001/XMLSchema”>

<soap:Body soap:encodingStyle=“http://schemas.xmlsoap.org/soap/encoding/”>

<tns:FindCustomer>

<EMailAddress xsi:type=“xsd:string”>gp@idea.com</EMailAddress>

</tns:FindCustomer>

</soap:Body>

</soap:Envelope>
Response:
<?xml version=“1.0”encoding=“utf-8”?>
<soap:Envelope xmlns:soap=“http://schemas.xmlsoap.org/soap/envelope/”
xmlns:soapenc=“http://schemas.xmlsoap.org/soap/encoding/“xmlns:tns=“http://aboveallsoftware.com/SouthcreekTutorial”
xmlns:types=“http://aboveallsoftware.com/SouthcreekTutorial/encodedTypes”
xmlns:xsi=“http://www.w3.org/2001/XMLSchema-instance” xmlns:xsd=“http://www.w3.org/2001/XMLSchema”>

<soap:Body soap:encodingStyle=“http://schemas.xmlsoap.org/soap/encoding/”>

<tns:FindCustomerResponse>

<Customer href=“#id1”/>

</tns:FindCustomerResponse>
<tns:Customer id=“id1” xsi:type=“tns:Customer”>

<CNumber xsi:type=“xsd:int”>11</CNumber>
<FirstName xsi:type=“xsd:string”>G</FirstName>
<LastName xsi:type=“xsd:string”>P</LastName>

</tns:Customer>

</soap:Body>

</soap:Envelope>
Request:
<?xml version=“1.0” encoding=“utf-8”?>
<soap:Envelope xmlns:soap=“http://schemas.xmlsoap.org/soap/envelope/”
xmlns:soapenc=“http://schemas.xmlsoap.org/soap/encoding/”xmlns:tns=“http://aboveallsoftware.com/SouthCreekTutorial/”
xmlns:types=“http://aboveallsoftware.com/SouthcreekTutorial/encodedTypes”
xmlns:xsi=“http://www.w3.org/2001/XMLSchema-instance” xmlns:xsd=“http://www.w3.org/2001/XMLSchema”>

<soap:Body soap:encodingStyle=
“http://schemas.xmlsoap.org/soap/encoding/”>

<tns:FindOrders>

<CustNum xsi:type=“xsd:int”>11</CustNum>

</tns:FindOrders>

</soap:Body>

</soap:Envelope>
Response:
<?xml version=“1.0” encoding=“utf-8”?>
<soap:Envelope xmlns:soap=“http://schemas.xmlsoap.org/soap/envelope/”
xmlns:soapenc=“http://schemas.xmlsoap.org/soap/encoding/”xmlns:tns=“http://aboveallsoftware.com/SouthcreekTutorial/”
xmlns:types=“http://aboveallsoftware.com/SouthcreekTutorial/encodedTypes”
xmlns:xsi=“http://www.w3.org/2001/XMLSchema-instance” xmlns:xsd=“http://www.w3.org/2001/XMLSchema”>

<soap:Body soap:encodingStyle=“http://schemas.xmlsoap.org/soap/encoding/”>

<tns:FindOrdersResponse>

<OrdersTable href=“#id1” />

</tns:FindOrdersResponse>
<tns:tableoforders id=“id1” xsi:type=“tns:tableoforders”>

<Orders href=“#id2” />

</tns:tableoforders>

<soapenc:Array id=“id2” soapenc:arrayType=“tns:Order[4]”>
<Item href=“#id3” />
<Item href=“#id4” />
<Item href=“#id5” />
<Item href=“#id6” />

</soapenc:Array>
<tns:Order id=“id3”xsi:type=“tns:Order”>

<Custnum xsi:type=“xsd:int”>11</Custnum>
<Onum xsi:type=“xsd:int”>681</Onum>
<OrderDate xsi:type=“xsd:dateTime>2001-03-06T00:00:00.0000000-06:00</OrderDate>
<ShipDate xsi:type=“xsd:dateTime”/>2000-03-07T00:00:00.0000000-06:00</ShipDate>

</tns:Order>
<tns:Order id=“id4” xsi:type=“tns:Order”>

<Custnum xsi:type=“xsd:int”>11</Custnum>
<Onum xsi:type=“xsd:int”>1475</Onum>
<OrderDate xsi:type=“xsd:dateTime”>2001-02-02T00:00:00.0000000-06:00</OrderDate>
<ShipDate xsi:type =“xsd:dateTime”>2001-02-06T00:00:00.0000000-06:00</ShipDate>

</tns:Order>
<tns:Order id=“id5”xsi:type=“tns:Order”>

<Custnum xsi:type=“xsd:int”>11</Custnum>
<Onum xsi:type=“xsd:int”>1486</Onum>
<OrderDate xsi:type=“xsd:dateTime”>2000-02-02T00:00:00.0000000-06:00</OrderDate>
<ShipDate xsi:type=“xsd:dateTime”>2000-02-03T00:00:00.0000000-06:00</ShipDate>

</tns:Order>
<tns:Order id=“id6” xsi:type=“tns:Order”>

<Custnum xsi:type=“xsd:int”>11</Custnum>
<Onum xsi:type=“xsd:int”>2342</Onum>
<OrderDate xsi:type=“xsd:dateTime”>2000-06-06T00:00:00.0000000-05:00</OrderDate>
<ShipDate xsi:type=“xsd:dateTime”>2000-06-07T00:00:00.0000000-05:00</ShipDate>

</tns:Order>

</soap:Body>

</soap:Envelope>

The form now provides all elements of the search: the user can type in the customer email address and find the orders. He can do this by noticing that the customer number was 11 in the Cnumber field and then typing that customer number into the Custnum field after clicking the FindOrders button. However, the user can arrange for the form to pass this information automatically, from the outputs of the FindCustomer operation to the inputs of the FindOrders operation, and can arrange for the FindOrders operation to be executed.

Numbers that come into the form from the Cnumber-field are drawn from the same domain of numbers that go into the Custnum field; that is, they are both drawn from the domain of customer numbers. Therefore, these fields can be joined together by clicking the Automatic AppJoin button in the tool bar (not shown). The user will be told about all the possible domain matches, either direct matches or matches indirectly available via transforms, that can be used to relate operations together. The user can select one of these matches by double clicking and or drag and drop.

Alternately, the user can simply click in the Cnumber field and drag over to the Custnum field, and release the mouse button, indicating the flow of information that they would like to occur, as shown in FIG. 5b. This would bring up the Join Toolbox, which explains the structure of the Join Relationships being created, shown in FIG. 5c.

With the AppJoin, the FindCustomer button takes on increased capabilities. When clicked, it will not only find the customer that is desired, but that action will cause the Cnumber to change in the dataset that holds the data that is displayed in the form. It is this changing of this piece of data that causes the “trigger” for the join relationship to fire. When the trigger fires, the input transform executes, which is available to be modified by clicking on the black circle on the line that represents the join relationship on the form as shown in FIG. 5b. In this case, the transform simply copies the data from the dataset element holding information to Cnumber to the dataset element holding information for Custnum.

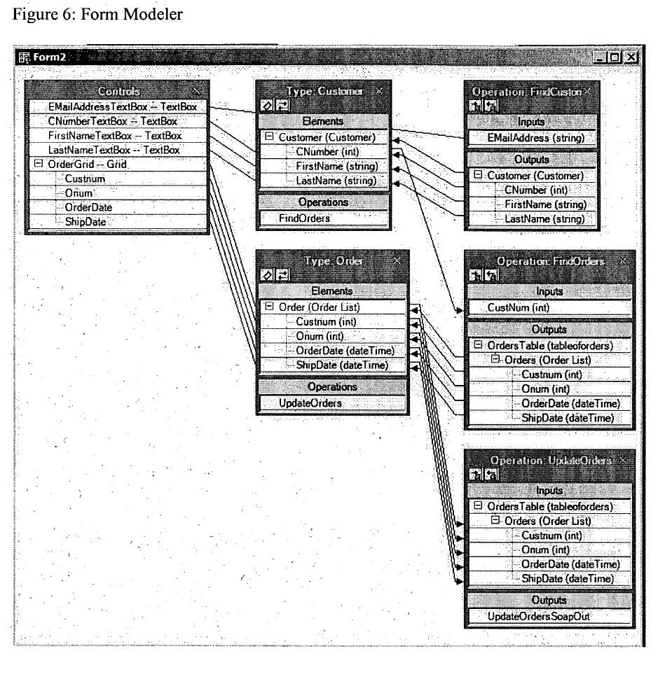

Using the Form Modeler; the user can see the dataset and its bindings to form controls and operations, shown in FIG. 6. Note that there is another transform, the output transform, that is available to modify what happens to the data as it is moved from the output of the operation into the dataset.

When the user clicks the new, improved version of the FindCustomer button, the cursor moves to the EMailNamne field. If the user types gpidea.com and clicks the Execute button, the FindCustomers and FindOrders operations are executed in a cascading sequence, shown in FIGS. 7b-c.

The cascading sequence is as follows. FindCustomer is called with: “gpidea.com” as the input parameter, and the value that is retrieved for the output parameter cnum is transformed and fed into the dataset. Then, it is transformed again as needed to be the input for the FindOrder operation parameter custnum, as that operation is called next in the sequence. The output parameters of FindOrder are displayed in the form, including the desired order information. Thus, the user creates a form that accepts a customer email address and retrieves the items the customer has ordered.

We have, for the sake of simplicity, glossed over that fact that the FindCustomer operation deals with something called an object type. Let's call this particular object type Customer. Customer might have several operations that produce a customer, delete a customer, update a customer, or otherwise manipulate one or more customers. Clearly, then, there is another object type we are dealing with here, which we will call Orders.

Note that if the first operation retrieved a table of customers, then if the user were to change the current row of that table by clicking on a different row in that table, that action would also trigger the join relationship to be executed because the current value of Cnumber had changed. This time, there would be no execution of the FindCustomer operation.

Therefore, the definition of a join relationship is a set of five basic components and a trigger. The five basic components, in this case are the Customer object type, the input transform, the FindOrders operation, the output transform, and the Orders object type. There is really only one operation that is involved in the definition of a join relationship; however, there are two object types involved. The data for the first object type might come from an execution of an operation but it may not. However, when the elements of that primary object type change, if any of those elements were part of the trigger set of elements, then the input transform, operation, and output transform are all executed.

As can be seen, in comparison to the prior art there is no pre-defined matrix that defines the relationship of various elements. The present invention uses a 5 part architecture, allowing for transforms in and out of an operation, and allows for the dynamic construction of relationships with drag and drop, not requiring that they have pre-existed in any matrix.

Finally, we provide for defining a relationship, with the 5 parts, using the enterprise object type construction dialogs. This could be construed to be a superset of such a matrix, however, we use drag and drop in this context only to provide transforms, which are not provided in the prior art, and when we provide drag and relate UI in the form user interface, it is because there are no such pre-defined relationships in any such matrix, we are, in effect, offering to create such relationships on the fly at that time.

Forms can be saved to the Application Dictionary to be used again later by the creator, or other users. They can be found using the semantic search mechanisms, including indirection, as described earlier.

When saving a form for the first time, the user can save additional information about the form so that it will be easy to locate again. The browser stores the form and the additional descriptive information in the Application Dictionary. One of the things that could be saved may be semantic information about what domain the elements that were used to create the relationship belong to. This domain information would then be available later, and to other users, when they create forms, or create relationships by any other means.

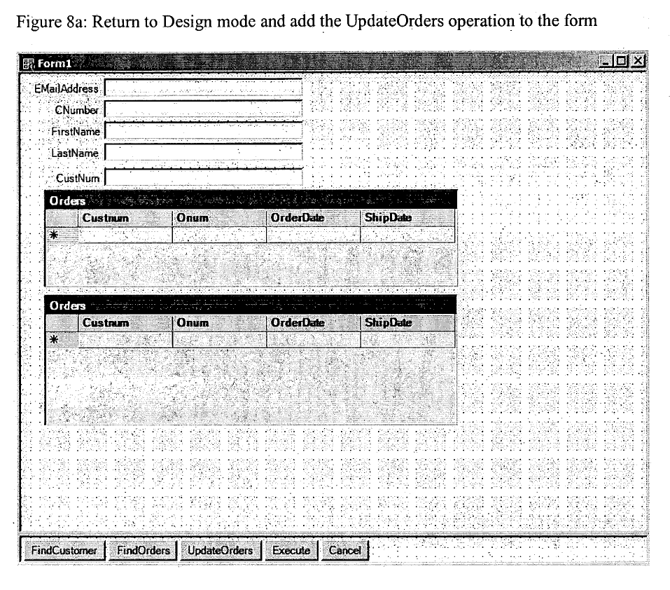

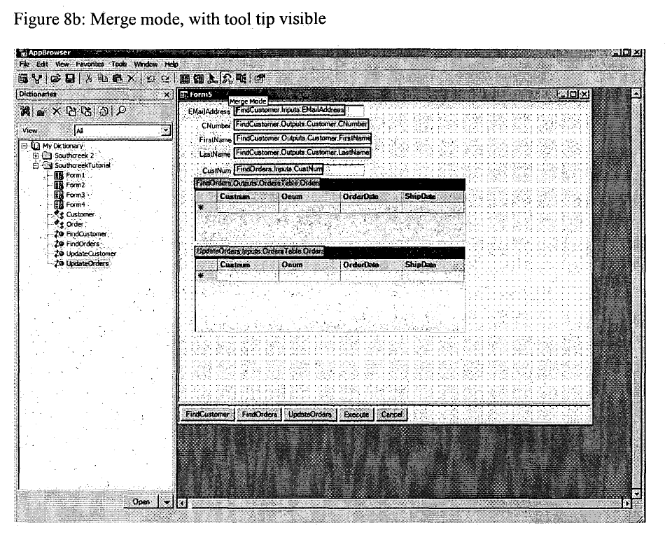

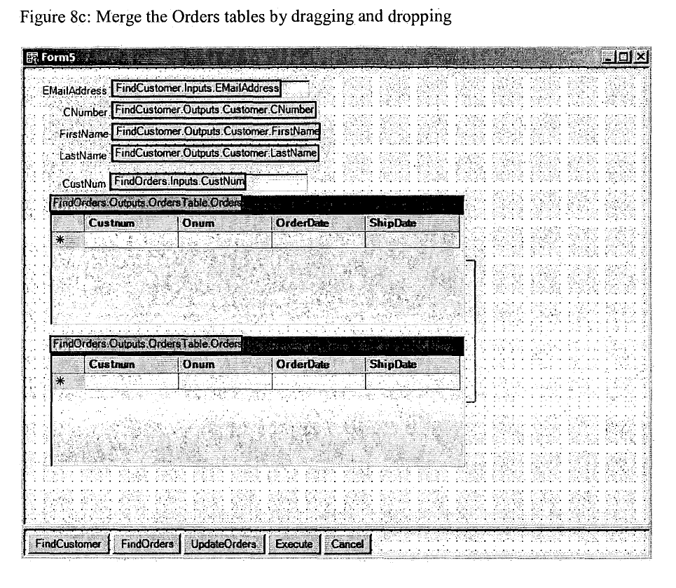

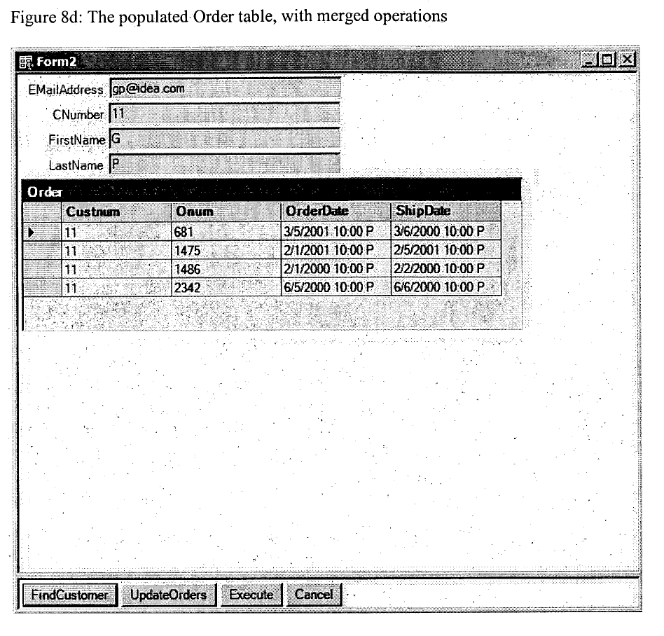

More operations can be added to a form, and there is another fundamentally important way for an operation to be related to the other operations in a form. For example, the, UpdateOrders operation has only one input parameter, which is the OrdersTable. If the user selects, drags, and drops theUpdateOrders operation into the form, this operation is added to the form's human interface and the form modeler view of the form. This is shown in FIG. 8a.

The user now has an UpdateOrders button and a second instance of the OrdersTable. If the user clicks the UpdateOrders button, the cursor moves to the second instance of the OrdersTable, and he can type new data to be sent to the UpdateOrders operation. This might be desirable if the operation was-intended to add new orders. However, to update orders, the user must start with the information that is in the first OrdersTable control that was on the screen. Therefore, the user must merge these two table controls together.

The user can merge two controls by selecting them and clicking the Merge button on the tool bar, or by selecting Merge from the Tools menu, and dragging one set of visual controls, such as the table control in this case, and dropping it on the other set that it is to be merged with. This is shown in, FIG. 8b.

After this AppMerge operation is completed, both table controls both point to the same contents of the dataset, shown in FIG. 8c.

When there is data in the dataset, and the user clicks the UpdateOrders button, changes the data in either of the merged controls, the data in the dataset will be changed. When the user clicks the Execute button, the modified data will be sent to theUpdateOrders operation. After the merge, one of the two redundant visual table controls in the form can be deleted, because only one is needed.

In summary, the invention provides for these manual methods for AppSelecting which operations are desired, and of performing an AppJoin operation to create a join relationship, and then AppMerging together two sets of visual controls so that they both point to the same elements of the dataset that holds their data. However, there is another way—a shortcut methodology-for performing these Application Algebra operations using the metadata in the Application Dictionary.

When the references to the operations, and the metadata about the operations, are imported into the Application Dictionary, the invention tries to determine what object types the operations operate upon, and adds such Enterprise Object Types (or EOTs) to the Application Dictionary as well. The invention further tries to'determine the associations between operations and EOTs. There is also a mechanism provided so the user can manually associate an operation with an EOT.

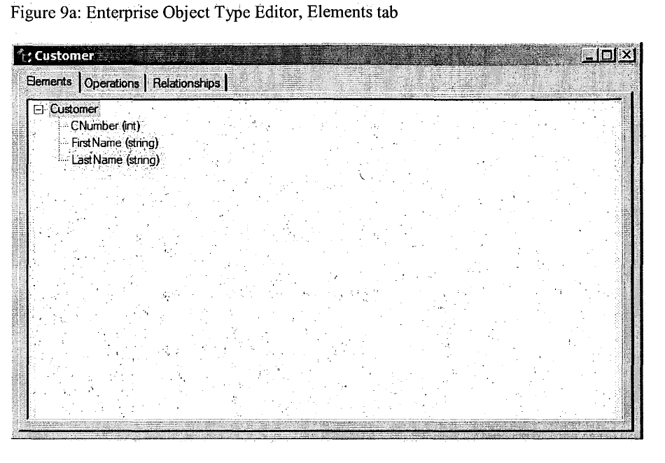

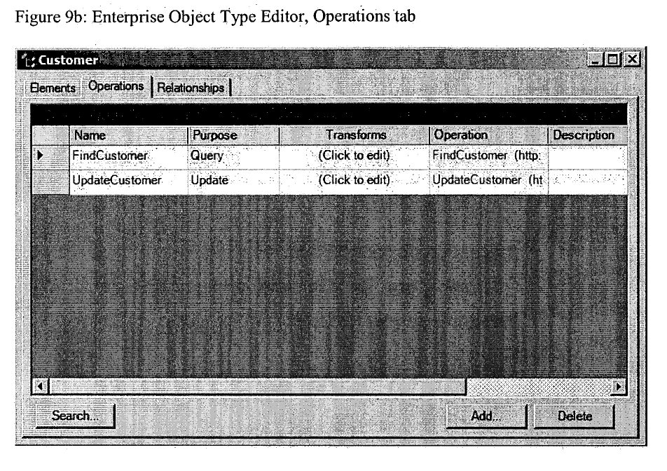

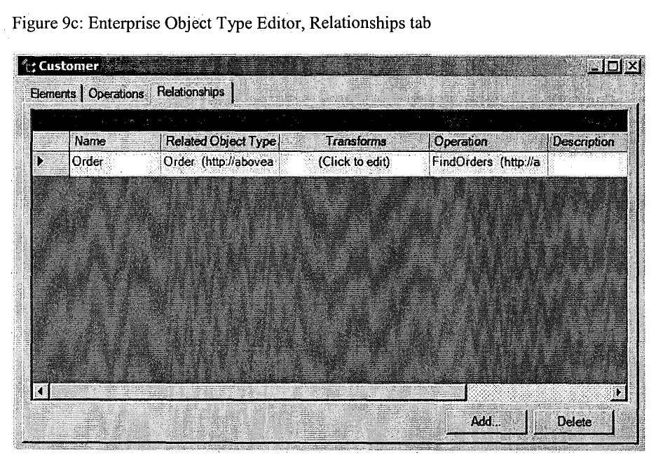

Since these operations may come from different enterprise information processing systems, these object types can be composite object types. They also may be imported at different times. Thus, another way to create a join relationship is as follows. The user could double click on an EOT in the Application Dictionary and open it, shown in FIG. 9a.

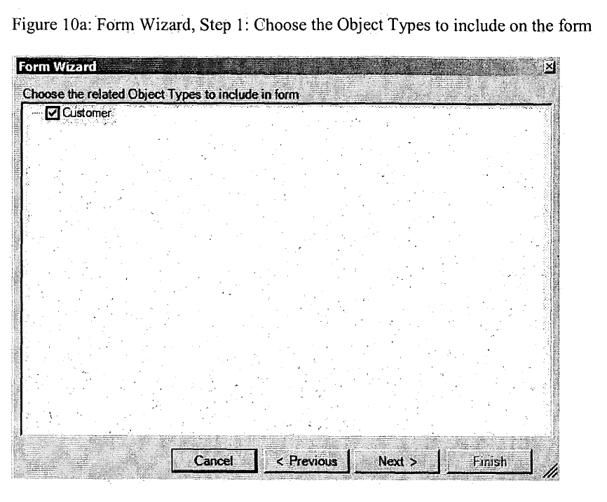

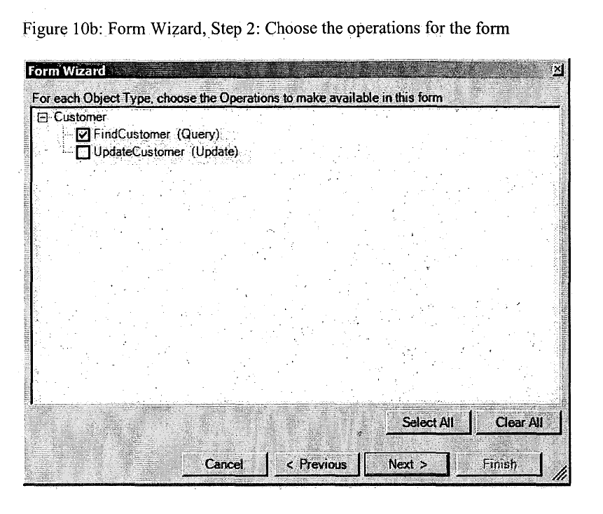

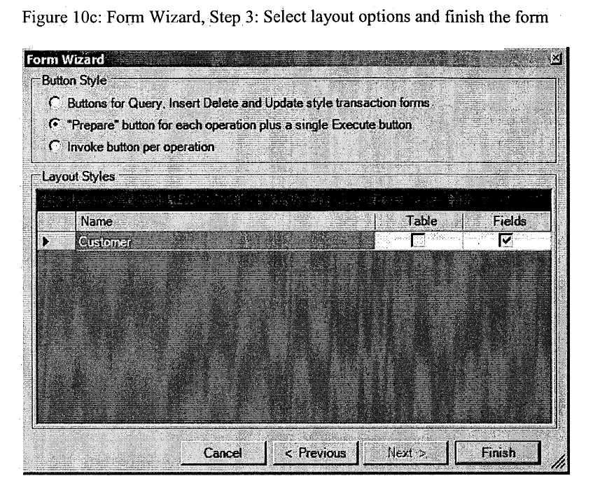

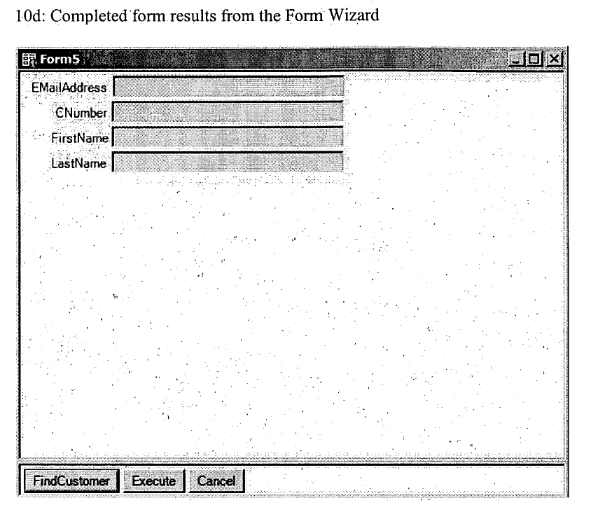

In this dialog box, shown in FIG. 9a, the user can view the elements of the object. In this example, the user can see the elements of a customer, as shown in FIG. 9b. The user can edit this element list, or create one from scratch if desired. Any operation that creates a customer, in this case, can be associated with this EOT, and also any operation that does anything useful with a customer, or regarding a customer, can be added to this list. FIG. 9b shows the elements associated with customers. Double clicking the Orders EOT reveals a similar structure (not shown). Forms can be built, possibly containing relationship joins and merges, automatically, as opposed to manually, by running a form wizard on these EOTs, shown in FIGS. 10a-c. FIGS. 10(a-c) show a wizard for the creation of forms, and FIG. 10d shows the result after running the wizard.

By selecting both FindOrders and UpdateOrders, the resultant form is the same form that was created manually using the AppMerge operation of the Application Algebra, and the buttons and tools that provide that functionality.

Also, if a relationship is added to an EOT, such as adding a relationship customers to orders, and indicating the transforms needed to make that relationship, then a form can be rendered with the AppJoin process performed automatically, producing the same join relationship in the form as though the manual process had been executed, shown in FIG. 10d.

For example, if the FindCustomer and UpdateCustomer operations are both in this list, then they can both be used in a form by running the form wizard.

You can also add a relationship between the Customer EOT and the Orders EOT. This is illustrated in FIGS. 1a-f.

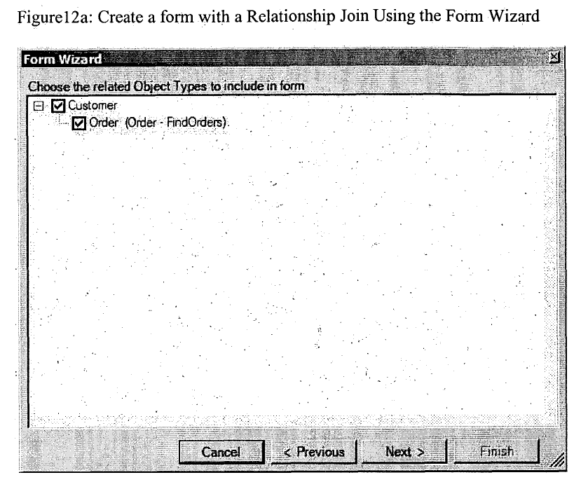

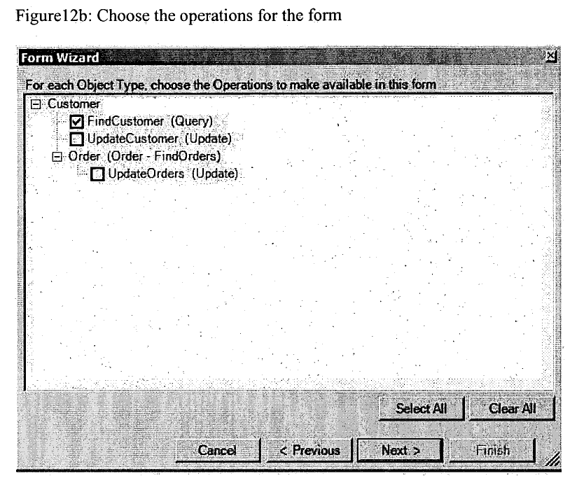

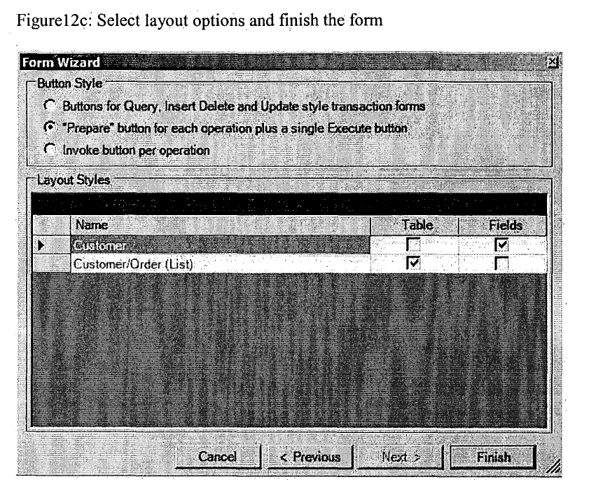

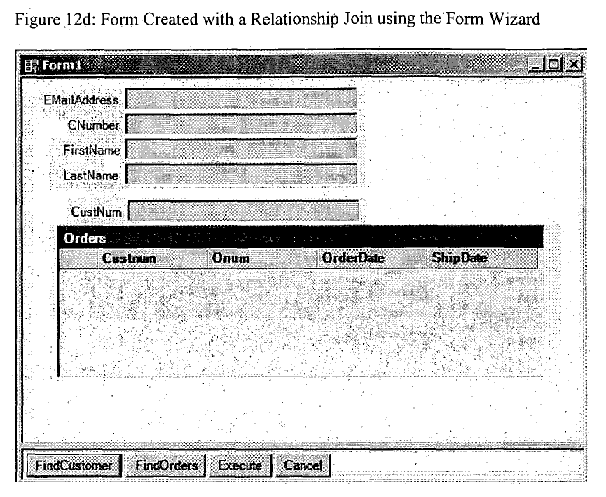

Now that a relationship exists between the Customer and the Order EOTs, the form wizard can be used to create a form that can find a customer, which will automatically use the FindOrders operation to find that customer's orders, and will also have the UpdateOrders operation available to change those orders, shown in FIGS. 12a-d.

Again, the join relationship in this form is the same as the one created using the manual techniques discussed earlier. The merge in this form is also the same as if it were created using the manual techniques.

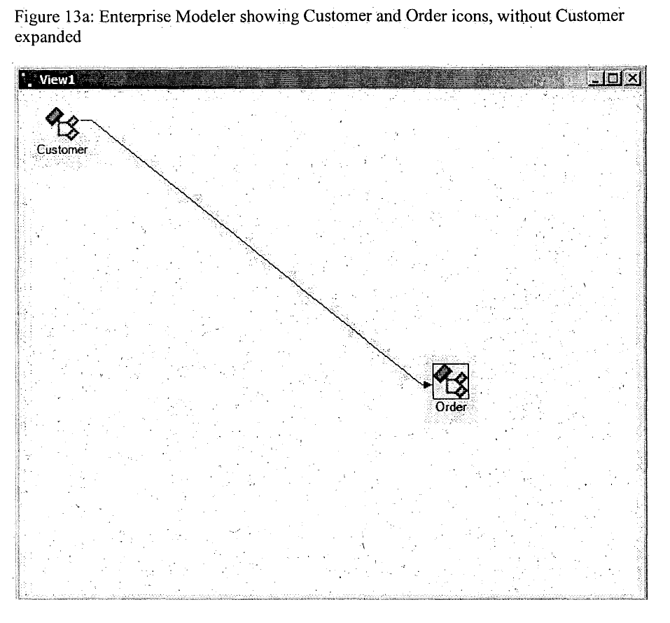

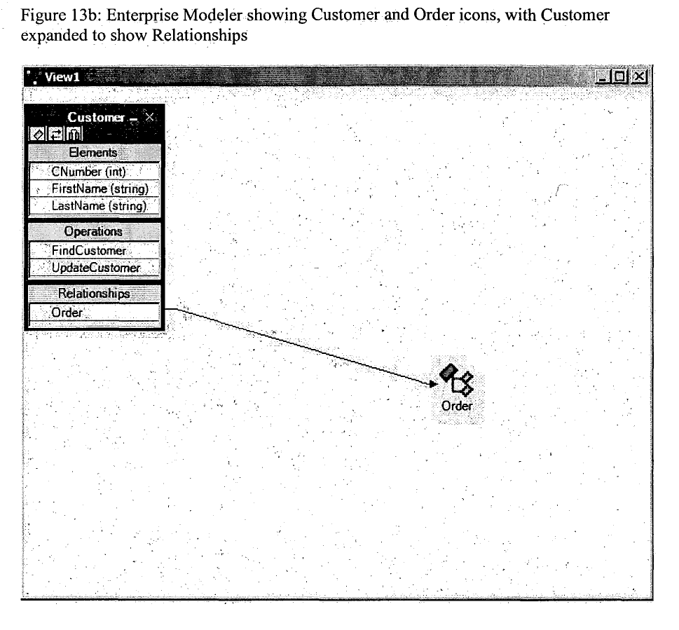

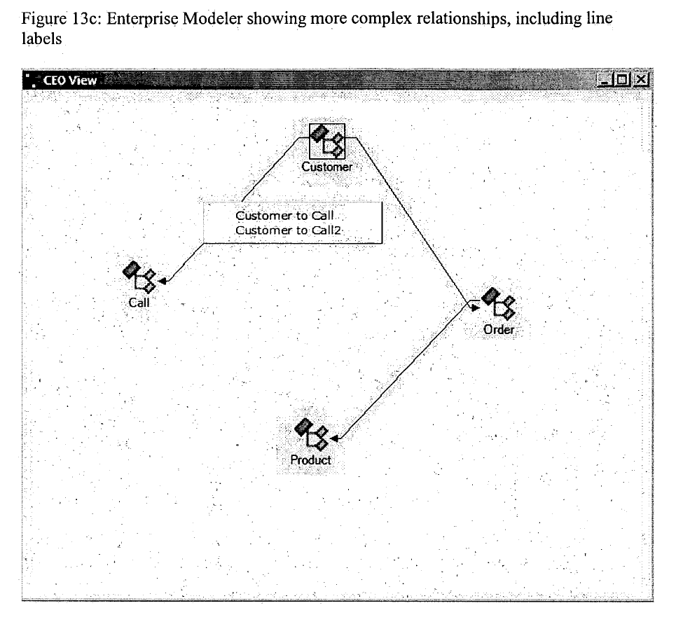

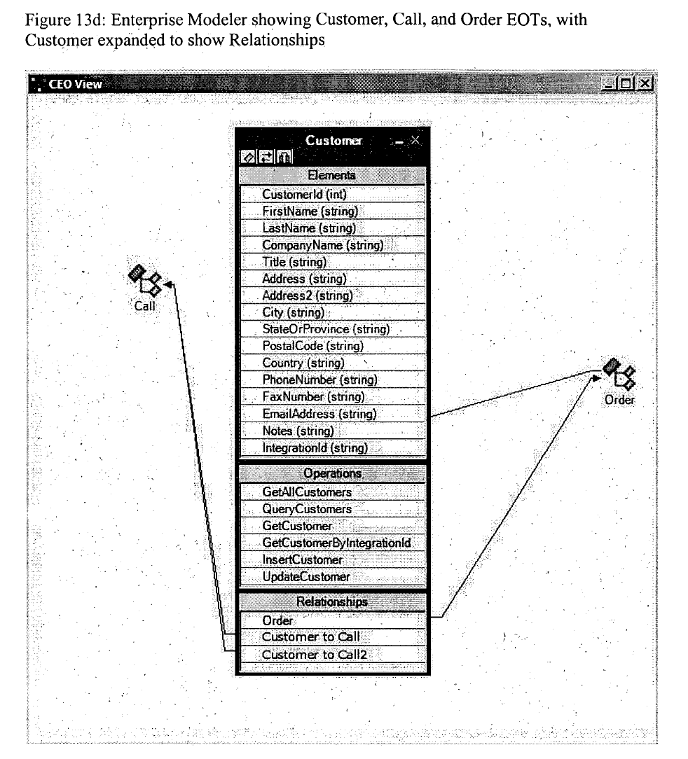

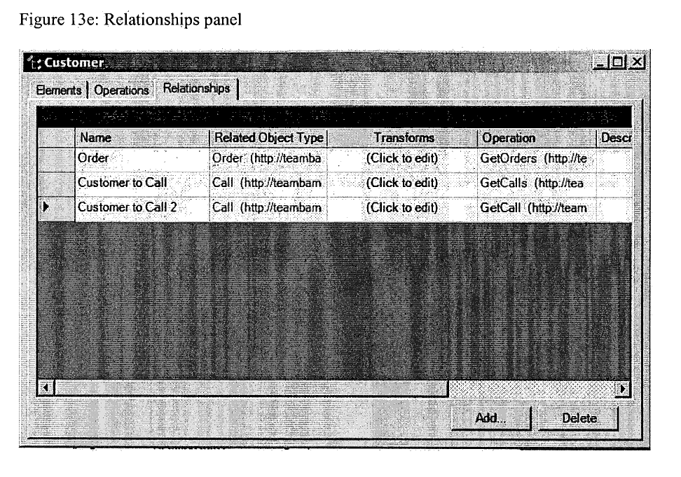

The invention provides for an easy visualization of what the contents of an EOT are and what the capabilities are of the operations that manipulate that EOT. This graphic representation is called the Enterprise Modeler. It will automatically render a “relationship line” for each, of the relationships that exist among the EOTs that are dragged and dropped into an Enterprise View. Also, the icon for an EOT, customer for example, can be double clicked to show the elements of the customer, the operations associated with the customer EOT and the relationships that have been created for the customer EOT, shown in FIGS. 13a-b. Also, icons can be associated with these renderings of the EOTs. A more complex Enterprise View that has additional EOTs with additional relationships is shown in FIGS. 13c-d, which can be edited in a dialog box as shown in FIG. 13e.

The process of selecting the desired operation is called an AppSelect. The process of selecting which fields to remove from the form is called an AppProject. The process of relating two fields together, because, they contain elements that are drawn from a common domain, or just manually asserting they are relatable, and thus creating a join relationship, is' called an AppJoin, and the process of making more than one set of visual controls source their data from the same elements in a form's dataset is called an AppMerge. The process of executing an operation, with the possibility of triggers firing and other operations and transforms being executed is called the AppExecute operation. These are all operations of the Application Algebra.

1. A method of dynamically relating a first operation to a second operation in forming a desired relationship, said method comprising:
searching in an application dictionary for operations involving one or more characteristics relating to the first operation and the second operation based on a user input;
selecting the first operation from said application dictionary;
selecting the second operation from the-application dictionary; and
joining said first operation to said second operation to form said desired relationship.

2. The method of claim 1 wherein said first operation comprises a first input and a first output and wherein said first operation operates said first input to obtain said first output.

3. The method of claim 2 wherein said second operation comprises a second input and a second output and wherein said second operation operates said second input to obtain said second output.

4. The method of claim 3 wherein said desired relationship provides said first output as said second input.

5. The method of claim 1 wherein said first operation operates on a first object type.

6. The method of claim 5 wherein said second operation operates on a second object type.

7. An article of manufacturing comprising:
a computer usable medium having computer readable program-code embodied therein configured to search in an application dictionary for operations involving one or more characteristics relating to the first operation and the second operation based on a user input;
a computer usable medium having computer readable program code embodied therein configured to select the first operation from said application dictionary;
a computer usable medium having computer readable program code embodied therein configured to select the second operation from the application dictionary; and
a computer usable medium having computer readable program code embodied therein configured to join said first operation to said second operation to form said desired relationship.

8. A computer system for dynamically relating a first operation to a second operation in forming a desired relationship, said computer system comprising:
a computer;
said computer executing a computer program comprising:
a computer usable medium having computer readable program code embodied therein configured to search in an application dictionary for operations involving one or more characteristics relating to the first operation and the second operation based on a user input;
a computer usable medium having computer readable program code embodied therein configured to select the first operation from said application dictionary;
a computer usable medium having computer readable program code embodied therein configured to select the second operation from the application dictionary; and
a computer usable medium having computer readable program code embodied therein configured to join said first operation to said second operation to form said desired relationship.

9. A method of establishing a desired relationship between a first object type, and a second object type comprising:
selecting the first object type;
selecting the second object type;
selecting the desired operation to be used to relate the first object type to the second object type;
establishing a desired transformation of data from the first object type to be input to the desired operation; and
establishing a desired transformation of the output of the desired operation to be data of the second object type.

10. An article of manufacturing comprising:
a computer usable medium having computer readable program code embodied therein configured to select the first object type;
a computer usable medium having computer readable program code embodied therein configured to select the second object type;
a computer usable medium having computer readable program code embodied therein configured to select the desired operation to be used to relate the first object type to the second object type;
a computer usable medium having computer readable program code embodied therein configured to establish a desired transformation of data from the first object type to be input to the desired operation; and
a computer usable medium having computer readable program code embodied therein configured to establish a desired transformation of the output of the desired operation to be data of the second object type.

11. A computer system comprising:
a computer;
said computer executing a computer program comprising:
a computer usable medium having computer readable program code embodied therein configured to select the first object type;
a computer usable medium having computer readable program code embodied therein configured to select the second object type;
a computer usable medium having computer readable program code embodied therein configured to select the desired operation to be used to relate the first object type to the second object type;
a computer usable medium having computer readable program code embodied therein configured to establish a desired transformation of data from the first object type to be input to the desired operation; and
a computer usable medium having computer readable program code embodied therein configured to establish a desired transformation of the output of the desired operation to be data of the second object type.
